(19) United States
(12) Patent Application Publication
(10) Pub. No.: US 2007/0044910 A1
(43) Pub. Date: Mar. 1, 2007

(54) Polyimide based flexible copper clad laminates and method of producing the same

(75) Inventors: Pei-Rong Kuo, Miaoli (TW); Kuo-Wei Li, Miaoli (TW)

Correspondence Address: BIRCH STEWART KOLASCH & BIRCH, PO BOX 747, FALLS CHURCH, VA, 22040-0747, US

(73) Assignee: THINFLEX CORPORATION

(21) Appl. No.: 11/294,387

(22) Filed: Dec. 6, 2005

(30) Foreign Application Priority Data
Aug. 31, 2005 (TW) 94129958

(51) Int. Cl. B32B 37/00; B32B 27/00; B32B 15/08; B32B 15/20

(52) U.S. Cl. 156/307.3; 428/458; 428/473.5; 428/220; 156/308.2

(57) ABSTRACT

The present invention relates to a polyimide based flexible copper clad laminate for manufacturing a flexible printed circuit board. The polyimide based flexible copper clad laminate comprises, in order, a copper foil, a thermoset polyimide layer, a thermoplastic polyimide layer, a thermoset polyimide layer, and a copper foil. The present invention also relates to a method for producing the polyimide copper foil laminate. First, a structure of copper foil coated with thermoset polyimide is formed. Then, the thermoset polyimide layers of two of the structures are adhered to each other by thermoplastic polyimide. Finally, after compressing and curing, the polyimide based flexible copper clad laminate according to the present invention is produced.

### RELATED APPLICATIONS

The present application is based on, and claims priority from, Taiwan Application Serial Number 94129958, filed Aug. 31, 2005, the disclosure of which is hereby incorporated by reference herein in its entirety.

### BACKGROUND

1. Field of Invention

The present invention relates to a polyimide based flexible copper clad laminate. More particularly, the present invention relates to a polyimide based flexible copper laminate for manufacturing a flexible printed circuit board. The present invention also relates to a method of producing the polyimide based flexible copper clad laminates.

2. Description of Related Art

Polyimide based flexible copper clad laminates are mainly used for manufacturing flexible printed circuit boards that are extensively applied to many electronic products such as laptop computers, mobile phones, personal digital assistants (PDA) and digital cameras. Since the design of electronic products has been trending to lighter, thinner and smaller products, the flexible printed circuit boards require lighter, thinner and smaller polyimide based flexible copper clad laminates.

In the conventional process for manufacturing a flexible printed circuit board, an adhesive is used for adhering a polyimide film to a copper foil. The resulting product then undergoes a laminating process. The copper foil, after undergoing photoresist coating, exposing, developing and wet etching processes, forms a predetermined circuit pattern. Since the conventional flexible printed circuit board has only one layer of a copper foil, a layout of circuits is so dense and complicated that cross talk occurs as the electronic products require higher speed and better performance. Cross talk is a voltage noise resulting from the mutual inductance of closed circuits with paths located near one another. That is, the changing magnetic field created by an alternating current in one circuit induces spurious signals in a neighboring circuit. Cross talk adversely affects the transmission of signals between circuits and is manifested especially in a high-density layout. The conventional flexible printed circuit board that has only one layer of the copper foil thus has its limitations.

In order to meet the demands of newly invented electronic products, which require denser circuits on a flexible printed circuit board, and to eliminate cross talk, a double-sided polyimide copper foil laminate with two layers of copper foils has been created. The double-sided design accommodates more circuits and hence allows higher circuit density. The conventional double-sided polyimide based flexible copper clad laminate comprises, in sequence, a copper foil, a thermoplastic polyimide layer, a thermoset polyimide layer, a thermoplastic polyimide layer, and a copper foil.

The conventional double-sided polyimide copper foil laminate is generally produced by stacking layer by layer. First, a thermoplastic polyimide layer is casted on a copper foil. Next, a thermoset polyimide layer is casted on the thermoplastic polyimide layer. Another thermoplastic polyimide layer is then casted on the thermoset polyimide layer. Finally, another copper foil is formed on the thermoplastic polyimide layer. After a laminating process, the conventional double-sided polyimide based flexible copper clad laminate is formed.

Another method for producing the conventional double-sided polyimide based flexible copper clad laminate is to coat both surfaces of a thermoset polyimide film with a thermoplastic polyimide layer. After a baking process, a structure comprising, in sequence, a thermoplastic polyimide layer, a thermoset polyimide film, and a thermoplastic polyimide layer is formed. Finally, a thermocompression process is performed at high temperature and high pressure to form a copper foil on both surfaces of the structure.

Conventional methods require repeated coating and compressing processes, which are complicated and time-consuming. Furthermore, the conventional double-sided polyimide based flexible copper clad laminate comprises two layers of thermoplastic polyimide. Since the stability and the controllability of the thermoplastic polyimide are much worse than those of the thermoset polyimide, one slip in the process leads to a dramatic decrease in product yield. Conventionally, the yield of the double-sided polyimide based flexible copper clad laminate is only about 70%, which means a great loss to manufacturers. Moreover, control over the thickness of the thermoset polyimide layer is not easy when using conventional methods. Since the thinnest thickness that the conventional methods can achieve is 25 microns, the double-sided polyimide copper foil laminate produced by the conventional methods cannot meet the requirement of ultra-thin products.

For the foregoing reasons, there is a need for a better method for producing thinner polyimide based flexible copper clad laminates and for increasing the yield.

### SUMMARY

It is therefore an aspect of the present invention to provide a polyimide based flexible copper clad laminate.

Another aspect of the present invention is to provide a method of producing the polyimide based flexible copper clad laminates.

In accordance with the foregoing aspects, the present invention provides a polyimide based flexible copper clad laminate comprising a first copper foil, a first thermoset polyimide layer located on the first copper foil; a second copper foil, and a second thermoset polyimide layer located on the second copper foil; and the first and the second thermoset polyimide layers are adhered to each other by a thermoplastic polyimide layer. The thermoset polyimide layer is formed by combining aromatic tetracarboxylic dianhydrides and aromatic diamines in different ratios to prepare a polyamic acid solution, casting the polyamic acid solution on the copper foil, and heating to form the thermoset polyimide layer on the copper foil. The polyimide copper foil laminate of the present invention is therefore produced.

In accordance with another aspect, the present invention provides a method for producing the polyimide based flexible copper clad laminates comprising, in sequence, a copper foil, a thermoset polyimide layer, a thermoplastic polyimide layer, a thermoset polyimide layer, and a copper foil. The method comprises the following steps. First, a structure with the thermoset polyimide layer positioned on the copper foil is formed by dissolving an aromatic tetracarboxylic dianhydride and an aromatic diamine in a polar aprotic solvent to form a polyamic acid solution, casting the polyamic acid solution onto the copper foil, and heating. Next, the thermoset polyimide layers of two of the structures previously formed are adhered to each other by a thermoplastic polyimide layer. Finally, a compressing process and a curing process are performed.

The polyimide based flexible copper clad laminate of the present invention has a structure totally different from that of any known polyimide copper foil laminates. The present invention does not need to produce the polyimide copper foil laminate layer-by-layer by repeated coating and laminating processes. Simply by performing one coating process, the present invention first produces a single-sided polyimide copper foil laminate, i.e. a structure with a thermoset polyimide layer positioned on a copper foil. Subsequently, two single-sided polyimide based flexible copper clad laminates are bound by thermoplastic polyimide to form the double-sided polyimide based flexible copper clad laminate of the present invention. Since the double-sided polyimide based flexible copper clad laminate of the present invention only comprises one layer of thermoplastic polyimide, control over the stability of sizes is much easier. Furthermore, the manufacturing process is simplified, and the yield increases from 70% to over 80%, which greatly lowers the production cost. In addition, the thickness of the totally polyimide layers can be varied according to the demands. Surprisingly, the thickness of the double-sided polyimide based flexible copper clad laminate can be lowered to 12.5 microns by employing the method of the present invention. Consequently, the polyimide based flexible copper clad laminate of the present invention is suitable for producing ultra-thin electronic products.

### BRIEF DESCRIPTION OF THE DRAWINGS

The invention can be more fully understood by reading the following detailed description of the preferred embodiments, with reference made to the accompanying drawings as follows:

FIG. 1 is a cross-sectional side view of a polyimide based flexible copper clad laminate of one preferred embodiment of the present invention.

### DETAILED DESCRIPTION OF THE PREFERRED EMBODIMENT

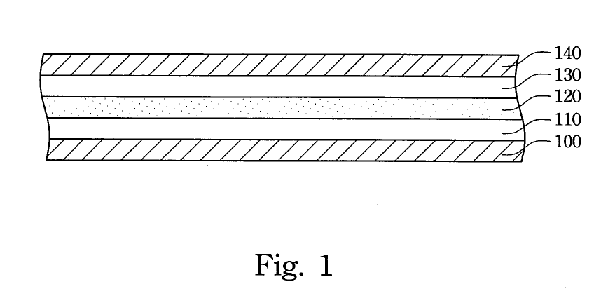

Reference is made to FIG. 1, which shows a cross-sectional side view of a polyimide based flexible copper clad laminate of one preferred embodiment of the present invention. The polyimide based flexible copper clad laminate comprises a first copper foil 100, a first thermoset polyimide layer 110 located on the first copper foil 100, a thermoplastic polyimide layer 120 located on the first thermoset polyimide layer 110, a second thermoset polyimide layer 130 located on the thermoplastic polyimide layer 120, and a second copper foil 140 located on the second thermoset polyimide layer 130.

The method for producing the aforementioned polyimide based flexible copper clad laminate comprises the following steps. In step a), a thermoset polyimide layer is formed on the copper foil. N-methyl-2-pyrrolidone, as a solvent, is added to a reaction tank at 35-50° C. Then, p-phenylenediamine and oxydianiline are added to the reaction tank with stirring, wherein the molar ratio of the p-phenylenediamine to the oxydianiline is about 0.1 to about 10.0, preferably about 1.0 to about 5.0. The p-phenylenediamine and oxydianiline can be replaced by N,N′-diphenylmethylenediamine, diaminobenzophenone or other aromatic diamine. After a twelve-hour stirring, 3,3′,4,4′-biphenyltetracarboxylic dianhydride is slowly added to the reaction tank with stirring. The 3,3′,4,4′-biphenyltetracarboxylic dianhydride can be replaced by pyromellitic dianhydride, benzophenonetetracarboxylic dianhydride or other aromatic tetracarboxylic dianhydride. After more than 8 hours stirring, a polyamic acid solution is obtained and is then spread onto a copper foil to form a thermoset polyimide layer on the copper foil by heating. In step b), the thermoset polyimide layers of two of the structures formed in step a) are adhered to each other by a thermoplastic polyimide layer. In step c), a compressing process is performed at high temperature and high pressure. In step d), a curing process is performed at high temperature.

The method of the present invention is different from that of the prior art and produces a polyimide copper foil laminate totally different from that of the prior art. Furthermore, the present invention increases the yield to over 80%. By applying the present invention, the thickness of the double-sided polyimide based flexible copper clad laminate can be varied according to the demands, even down to 12.5 microns. Therefore, the polyimide copper foil laminate of the present invention is suitable for producing ultra-thin electronic products.

The preferred embodiment of the present invention described above should not be regarded as a limitation of the present invention. It will be apparent to those skilled in the art that various modifications and variations can be made to the present invention without departing from the scope or spirit of the invention.

The scope of the present invention is as defined in the appended claims.

What is claimed is:

1. A double-sided polyimide based flexible copper clad laminate for manufacturing a flexible printed circuit board, wherein the copper foil laminate comprises:
a first copper foil;
a first thermoset polyimide layer located on the first copper foil;
a thermoplastic polyimide layer located on the first thermoset polyimide layer;
a second thermoset polyimide layer located on the thermoplastic polyimide layer; and
a second copper foil located on the second thermoset polyimide layer.

2. The polyimide based flexible copper clad laminate of claim 1, wherein the material of first thermoset polyimide layer and the second thermoset polyimide layer is a polyimide polymized by an aromatic tetracarboxylic dianhydride and an aromatic diamine.

3. The polyimide based flexible copper clad laminate of claim 2, wherein the aromatic tetracarboxylic dianhydride is selected from the group consisting of 3,3′,4,4′-biphenyltetracarboxylic dianhydride, pyromellitic dianhydride and benzophenonetetracarboxylic dianhydride.

4. The polyimide based flexible copper clad laminate of claim 2, wherein the aromatic diamine is selected from the group consisting of p-phenylenediamine, oxydianiline, N,N′-diphenylmethylenediamine and diaminobenzophenone.

5. The polyimide based flexible copper clad laminate claim 2, wherein the aromatic tetracarboxylic dianhydride is 3,3′,4,4′-biphenyltetracarboxylic dianhyd ride.

6. The polyimide based flexible copper clad laminate of claim 5, wherein the aromatic diamine is mixture of p-phenylenediamine and oxydianiline.

7. The polyimide based flexible copper clad laminate of claim 6, wherein the molar ratio of p-phenylenediamine/oxydianiline is about 0.1 to about 10.0.

8. The polyimide based flexible copper clad laminate of claim 6, wherein the molar ratio of p-phenylenediamine/oxydianiline is about 1.0 to about 5.0.

9. The polyimide based flexible copper clad laminate of claim 2, wherein a thickness of the copper foil laminate is less than 25 microns.

10. A method of producing a double-sided polyimide based flexible copper clad laminate, the method comprises:
a) casting a thermoset polyimide layer on a copper foil to form a structure with the thermoset polyimide layer located on the copper foil;
b) adhering the thermoset polyimide layers of two of the structures formed in step a) to each other by a thermoplastic polyimide;
c) compressing; and
d) curing.

11. The method of claim 10, wherein step a) is performed by dissolving an aromatic tetracarboxylic dianhydride and an aromatic diamine in a polar aprotic solvent to form a polyamic acid solution, casting the polyamic acid solution on the copper foil, and heating to form the thermoset polyimide layer on the copper foil.

12. The method of claim 11, wherein the aromatic tetracarboxylic dianhydride is selected from the group consisting of 3,3′,4,4′-biphenyltetracarboxylic dianhydride, pyromellitic dianhydride and benzophenonetetracarboxylic dianhydride.

13. The method of claim 11, wherein the aromatic diamine is selected from the group consisting of p-phenylenediamine, oxydianiline, N,N′-diphenylmethylenediamine and diaminobenzophenone.

14. The method of claim 11, wherein the aromatic tetracarboxylic dianhydride is 3,3′,4,4′-biphenyltetracarboxylic dianhydride.

15. The method of claim 14, wherein the aromatic diamine is prepared by combining p-phenylenediamine and oxydianiline.

16. The method of claim 15, wherein the molar ratio of p-phenylenediamine/oxydianiline is about 0.1 to about 10.0.

17. The method of claim 15, wherein the molar ratio of p-phenylenediamine/oxydianiline is about 1.0 to about 5.0.
